(19) United States
(12) Patent Application Publication
(10) Pub. No.: US 2023/0055681 A1
(43) Pub. Date: Feb. 23, 2023

(54) SERVER, INFORMATION PROCESSING SYSTEM, AND INFORMATION PROCESSING METHOD

(71) Applicant: TOYOTA JIDOSHA KABUSHIKI KAISHA, Aichi-ken (JP)

(72) Inventors: Daiki YOKOYAMA, Gotemba-shi (JP); Toshiya HASHIMOTO, Miyoshi-shi (JP); Katsuya KOBAYASHI, Okazaki-shi (JP); Takahiro HIRANO, Gotemba-shi (JP); Midori SUGIYAMA, Susono-shi (JP); Ryunosuke YAMASHITA, Susono-shi (JP)

(21) Appl. No.: 17/889,391

(22) Filed: Aug. 17, 2022

(30) Foreign Application Priority Data
Aug. 18, 2021 (JP) 2021-133296

(51) Int. Cl. G06Q 10/08; H02J 50/10; H02J 50/40; B60L 53/12; G06Q 30/06

(52) U.S. Cl. CPC G06Q 10/087; H02J 50/10; H02J 50/40; B60L 53/12; G06Q 30/0645

(57) ABSTRACT

A plurality of power feed mats are stored as being distributed at a plurality of storage locations, and each of the plurality of power feed mats is configured to supply electric power to a movable body. A server includes a memory and a processor. Data in which an identification number, a type, and a storage location of each of the plurality of power feed mats are associated with one another is stored in the memory. The processor determines at least one power feed mat to be rented based on the data, in response to an inquiry from a user. The processor determines a storage location to be a source of rental or a storage location to be a return destination such that inventory of a plurality of types of power feed mats is ensured at each of the plurality of storage locations.

This nonprovisional application is based on Japanese Patent Application No. 2021-133296 filed with the Japan Patent Office on Aug. 18, 2021, the entire contents of which are hereby incorporated by reference.

### BACKGROUND

### Field

The present disclosure relates to a server, an information processing system, and an information processing method.

### Description of the Background Art

A power feed mat that is portable and can wirelessly charge a vehicle and the like has conventionally been known. For example, Japanese Patent Laying-Open No. 2014-236540 discloses a power transmission coil member including a power transmission coil that transmits electromagnetic waves for power transmission to a power reception coil mounted on a vehicle and a sheet material that covers the power transmission coil.

### SUMMARY

A business operator (for example, a lease company) can manage a plurality of power feed mats and rent at least one power feed mat to a user in response to an inquiry from the user. In this case, the plurality of power feed mats may be stored as being distributed at a plurality of storage locations. A power feed mat can thus be shipped from a storage location close to a location designated by the user (for example, a location of placement of the power feed mat). On the other hand, in distributed storage at the plurality of storage locations, inventory should appropriately be managed.

An object of the present disclosure is to provide a server, an information processing system, and an information processing method that appropriately manage inventory of power feed mats when a plurality of power feed mats are stored as being distributed at a plurality of storage locations.

(1) A server according to one aspect of the present disclosure manages a plurality of power feed mats. The plurality of power feed mats are stored as being distributed at a plurality of storage locations, and each of the power feed mats is configured to supply electric power to a movable body. The server includes a storage that stores data in which an identification number, a type, and a storage location of each of the plurality of power feed mats are associated with one another, a processor that determines at least one power feed mat to be rented among the plurality of power feed mats based on the data, in response to an inquiry from a user, and an output device that outputs determination by the processor. The processor determines a storage location from which the power feed mat is to be rented (a source of rental) or a storage location to which the power feed mat is to be returned (a return destination) among the plurality of storage locations such that inventory of a plurality of types of power feed mats is ensured at each of the plurality of storage locations.

(2) The processor determines a storage location where the inventory of at least one type of the plurality of types of power feed mats is excessive, as the storage location to be the source of rental.

(3) The processor determines a storage location where the inventory of at least one type of the plurality of types of power feed mats is insufficient, as the storage location to be the return destination.

(4) The processor determines to replenish the inventory from a storage location where the inventory is excessive to a storage location where the inventory is insufficient, for at least one type of the plurality of types of power feed mats.

In the configuration in (1) to (4), the processor determines a storage location to be a source of rental or a return destination of a power feed mat such that inventory of a plurality of types of power feed mats is ensured at each of the plurality of storage locations. For example, a storage location where inventory of power feed mats of a type that fulfills the inquiry is excessive is determined as the source of rental. A storage location where inventory of power feed mats of a type that fulfills the inquiry is insufficient is determined as the return destination. Alternatively, replenishment of inventory from the storage location where inventory is excessive to the storage location where inventory is insufficient is determined. Shortage of inventory of power feed mats at each storage location can be suppressed, and inventory of power feed mats can appropriately be managed.

(5) Each of the plurality of power feed mats includes a substrate including a power transmission coil and a functional body that performs at least one function of a plurality of functions different from a power feed function. The inquiry includes an instruction that designates the at least one function.

(6) The plurality of functions include at least one of a function to reduce stress concentration, a waterproof function, a snow melting function, a heat radiation function, a representation function, an electromagnetic wave shielding function, a foreign matter sensing function, and a living body sensing function.

(7) The output device outputs determination by the processor to a terminal device configured to communicate with the server.

(8) An information processing system according to another aspect of the present disclosure includes the above-described server and the terminal device.

(9) An information processing method according to yet another aspect of the present disclosure manages a plurality of power feed mats stored as being distributed at a plurality of storage locations, each of the plurality of power feed mats being configured to supply electric power to a movable body. The information processing method includes accepting, by an information processing apparatus, an inquiry about rental from a user and determining, by the information processing apparatus, a type of a power feed mat to be rented among the plurality of power feed mats in response to the inquiry, based on data in which an identification number, a type, and a storage location of each of the plurality of power feed mats are associated with one another. The determining includes determining a storage location to be a source of rental or a storage location to be a return destination among the plurality of storage locations such that inventory of a plurality of types of power feed mats is ensured at each of the plurality of storage locations.

According to the method in (9), as in the configuration in (1), when a plurality of power feed mats are stored as being distributed at a plurality of storage locations, inventory of the power feed mats can appropriately be managed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a configuration of a wireless charging system including a power feed mat.

FIG. 2 is an exemplary cross-sectional view of the power feed mat along the line II-II in FIG. 1.

FIG. 3 is another exemplary cross-sectional view of the power feed mat along the line II-II in FIG. 1.

FIG. 4 is yet another exemplary cross-sectional view of the power feed mat along the line II-II in FIG. 1.

FIG. 5 is a diagram showing a schematic configuration of an information processing system according to the present embodiment.

FIG. 6 is a block diagram showing a typical hardware configuration of a server.

FIG. 7 is a block diagram showing a typical hardware configuration of a terminal device.

FIG. 8 is a functional block diagram showing a functional configuration of the server and the terminal device.

FIG. 9 is a diagram for illustrating overview of management of inventory of a power feed mat 10 carried out in the present embodiment.

FIG. 10 is a first conceptual diagram for illustrating a schematic configuration of a data table.

FIG. 11 is a second conceptual diagram for illustrating a schematic configuration of a data table.

FIG. 12 is a diagram showing a log-in screen of the terminal device.

FIG. 13 is a first diagram showing an input screen for making an inquiry about rental of a power feed mat.

FIG. 14 is a second diagram showing an input screen for making an inquiry about rental of a power feed mat.

FIG. 15 is a diagram showing a screen of a result of an estimate of the power feed mat.

FIG. 16 is a sequence diagram for illustrating a flow of processing performed in the information processing system.

### DESCRIPTION OF THE PREFERRED EMBODIMENTS

An embodiment of the present disclosure will be described below in detail with reference to the drawings. The same or corresponding elements in the drawings have the same reference characters allotted and description thereof will not be repeated.

### Embodiment

<Basic Function of Power Feed Mat>

A schematic configuration of a power feed mat to be rented in the present embodiment and exemplary use of the power feed mat will be described. “Rental” in the present disclosure is a concept encompassing lease.

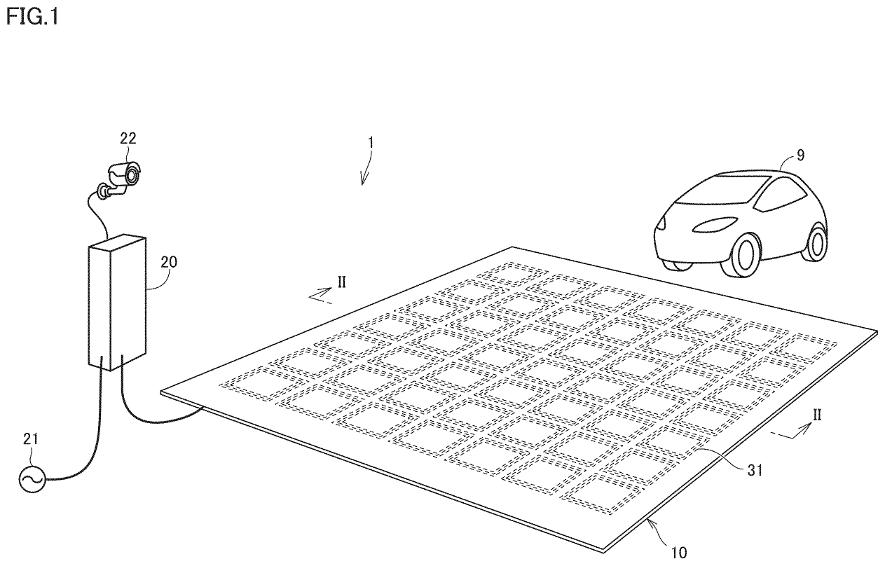

FIG. 1 is a perspective view schematically showing a configuration of a wireless charging system including a power feed mat. A wireless charging system 1 includes a power feed mat 10 and a power feed apparatus 20.

Power feed mat 10 is used for power feed to a movable body 9. Movable body 9 includes a power reception coil and a power storage neither of which is shown. As shown in FIG. 1, movable body 9 is, for example, a vehicle. Examples of the vehicle include a hybrid electric vehicle (HEV), a plug-in hybrid electric vehicle (PHEV), a battery electric vehicle (BEV), an autonomous robot (a micropalette) capable of transporting a load without human intervention, and a small mobility with a seat capacity of one or two passengers. Movable body 9 may be an unmanned aerial vehicle (UVA) which is also referred to as a drone.

Power feed mat 10 can wirelessly transmit electric power to movable body 9. Power feed mat 10 may be placed on a road surface or on a wall surface. Power feed mat 10 may be flexible or pliable as being rolled.

More specifically, power feed mat 10 includes a plurality of power transmission coils 31. Power transmission coil 31 is configured to wirelessly transmit electric power to a power reception coil mounted on movable body 9. While the power reception coil is located above power transmission coil 31, power transmission coil 31 sends electromagnetic waves for power transmission to that power reception coil. The power reception coil charges a power storage mounted on movable body 9 with electric power generated based on the electromagnetic waves. Power transmission coil 31 may be formed in a quadrangular shape in a plan view as shown in FIG. 1 or in a hexagonal shape in the plan view. Alternatively, power transmission coil 31 may be formed in a shape (for example, a shape of a solenoid) different from the quadrangular shape and the hexagonal shape in the plan view. Power feed mat 10 may include a single power transmission coil 31.

Power feed apparatus 20 supplies electric power to power feed mat 10. Power feed apparatus 20 can be connected to an alternating-current (AC) power supply 21. Power feed apparatus 20 converts a voltage of AC power supplied from AC power supply 21 into an appropriate value and supplies resultant AC power to power feed mat 10.

Power feed apparatus 20 may include a sensor unit 22. Sensor unit 22 includes, for example, at least one of a camera, a radar, and a laser imaging detection and ranging (LIDAR). Sensor unit 22 detects a position of movable body 9 that passes over power feed mat 10. Electric power can thus be fed from power transmission coil 31 located below movable body 9 to movable body 9.

<Additional Function of Power Feed Mat>

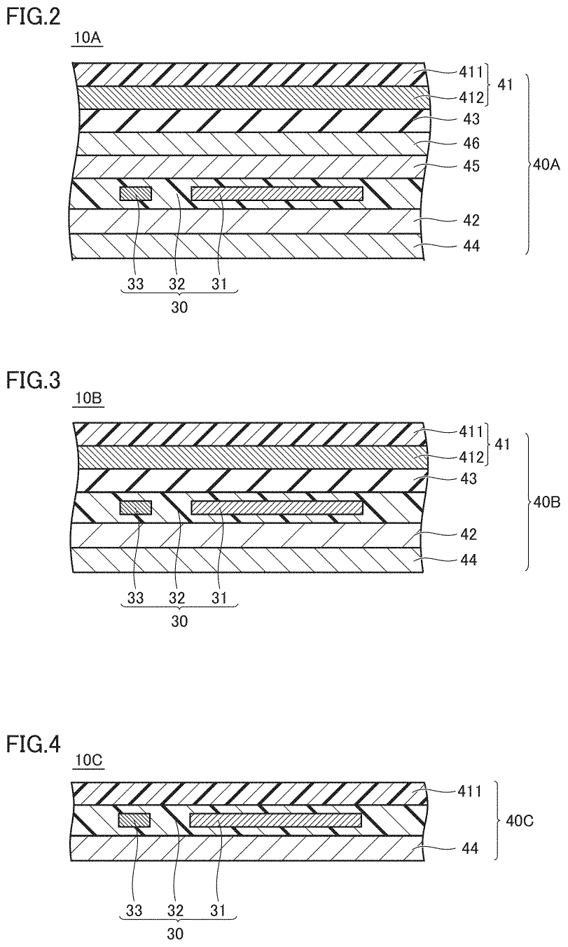

Power feed mat 10 can perform various functions (which are also referred to as “additional functions” below) other than a power feed function as a basic function. In this example, a “type” of power feed mat 10 depending on the basic function or the additional function is set. One power feed mat 10 may perform zero additional function, one additional function, or a plurality of additional functions. The additional function is performed by a functional layer which will be described later. In this example, rental of power feed mat 10 is managed in consideration of both of the basic function and the additional function of power feed mat 10. Overview of three types of power feed mats 10A, 10B, and 10C will be described below with reference to FIGS. 2 to 4. When the type of power feed mats is not distinguished, power feed mats are simply denoted as “power feed mat 10.”

FIG. 2 is an exemplary cross-sectional view of the power feed mat along the line II-II in FIG. 1. Power feed mat 10A includes a substrate 30 and a functional body 40A. Substrate 30 includes at least one power transmission coil 31, a cover sheet 32, and an antenna 33. In this example, substrate 30 includes a plurality of power transmission coils 31.

Cover sheet 32 covers power transmission coil 31. Cover sheet 32 is composed of glass, an epoxy resin, or the like.

Antenna 33 is provided within cover sheet 32. Antenna 33 is, for example, a loop antenna. Antenna 33 superimposes on electromagnetic waves sent from power transmission coil 31 to a power reception coil of movable body 9, information lower in frequency than the electromagnetic waves. Examples of the information include position information of movable body 9, an amount of power feed requested by movable body 9, and an identification number of movable body 9.

Functional body 40A includes a plurality of functional layers. More specifically, functional body 40A includes an upper protective layer 41, a heat radiation layer 42, a representation layer 43, a shield layer 44, a foreign matter sensing layer 45, and a living body sensing layer 46. Each functional layer is provided above or below substrate 30, depending on a function.

Upper protective layer 41 is provided above substrate 30 and performs a function to protect substrate 30. In this example, upper protective layer 41 includes a first protective layer 411 and a second protective layer 412.

First protective layer 411 reduces stress concentration to substrate 30 caused by a weight of movable body 9 (a load carrying function or a vibration resistant function) and improves waterproofness of substrate 30 (a waterproof function). First protective layer 411 is composed of a material (polycarbonate or the like) higher in rigidity than cover sheet 32. Alternatively, first protective layer 411 is composed of a material (rubber or the like) lower in rigidity than cover sheet 32. First protective layer 411 is preferably composed of a light-transmissive material.

Second protective layer 412 is provided on a lower surface of first protective layer 411. Second protective layer 412 includes a heating unit such as a heater. This heating unit is activated when accumulation of snow on first protective layer 411 is sensed (a snow melting function). Second protective layer 412 is also preferably composed of a light-transmissive material.

Heat radiation layer 42 performs a function to radiate heat of substrate 30 (a heat radiation function). Heat radiation layer 42 is provided as being in contact with an upper surface or a lower surface of substrate 30. In this example, heat radiation layer 42 is provided as being in contact with the lower surface of substrate 30, however, heat radiation layer 42 may be provided as being in contact with the upper surface of substrate 30. Heat radiation layer 42 is composed of a material higher in thermal conductivity than cover sheet 32 of substrate 30. Heat radiation layer 42 is formed, for example, by adding thermally conductive particles to silicone rubber.

Representation layer 43 performs a representation function. Representation layer 43 is provided above substrate 30. When upper protective layer 41 is provided above substrate 30, representation layer 43 is provided between substrate 30 and upper protective layer 41. Representation layer 43 can show a prescribed image by optical representation. Examples of the representation include an image (a traffic sign) that navigates or guides movable body 9. The representation is changed as appropriate by power feed apparatus 20. Representation by representation layer 43 can be read by a camera (not shown) mounted on movable body 9.

Shield layer 44 performs a function as a shield against electromagnetic waves (a shielding function). In this example, shield layer 44 is provided below heat radiation layer 42. Shield layer 44 contains a material (a metal or ferrite) capable of acting as a shield against electromagnetic waves.

Foreign matter sensing layer 45 performs a function to sense a foreign matter (a metallic foreign matter or the like) present above substrate 30 (a foreign matter sensing function). Foreign matter sensing layer 45 is provided as being in contact with the upper surface of substrate 30. Foreign matter sensing layer 45 includes a coil that detects a metal.

Living body sensing layer 46 performs a function to sense a living body (a human or an animal) present above substrate 30 (a living body sensing function). Living body sensing layer 46 is provided above substrate 30. As shown in FIG. 2, living body sensing layer 46 may be provided as being in contact with an upper surface of foreign matter sensing layer 45 or with the upper surface of substrate 30. Living body sensing layer 46 includes, for example, a sensor that senses a capacitance.

FIG. 3 is another exemplary cross-sectional view of the power feed mat along the line II-II in FIG. 1. Power feed mat 10B includes substrate 30 and a functional body 40B. In an example in FIG. 3, functional body 40B includes as the plurality of functional layers, upper protective layer 41, heat radiation layer 42, representation layer 43, and shield layer 44. Power feed mat 10B is different from power feed mat 10A in FIG. 2 in not including foreign matter sensing layer 45 and living body sensing layer 46.

FIG. 4 is yet another exemplary cross-sectional view of the power feed mat along the line II-II in FIG. 1. Power feed mat 10C includes substrate 30 and a functional body 40C. In an example in FIG. 4, functional body 40C includes as the plurality of functional layers, first protective layer 411 and shield layer 44. Power feed mat 10C is different from power feed mat 10A in FIG. 2 in not including second protective layer 412, heat radiation layer 42, representation layer 43, foreign matter sensing layer 45, and living body sensing layer 46.

Though not shown, functional body 40 (40A to 40C) may include a power generation layer that performs a power generation function as one of the plurality of functional layers. The power generation layer is preferably composed of a solar photovoltaic panel. The power generation layer may be provided, for example, instead of representation layer 43.

In these examples, functional body 40 includes a plurality of functional layers and provides a plurality of additional functions. Functional body 40, however, may be configured to include a single functional layer and to provide a single additional function. An order of layering in a vertical direction of each functional layer with respect to substrate 30 is determined depending on the function of the functional layer and relation with the function of another functional layer. There is a functional layer a layering position of which is uniquely defined, such as shield layer 44, whereas there is a functional layer a layering position of which is not uniquely defined.

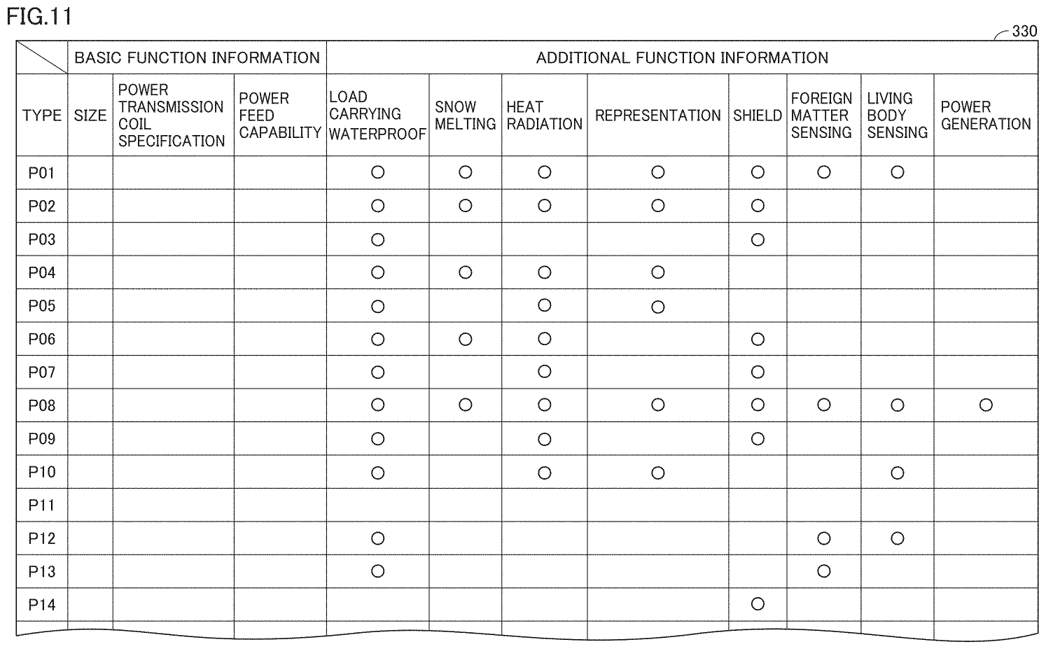

For confirmation, three types of power feed mats 10 (10A to 10C) shown in FIGS. 2 to 4 are merely exemplary configurations of power feed mat 10 as shown later in FIG. 11. The type of power feed mat 10 is not limited to these three. Power feed mat 10 that performs only a basic function (power feed function) is also to be rented.

<Schematic Configuration of Information Processing System>

An information processing system for rental of power feed mat 10 will be described below. Various types of power feed mats 10 are available as described previously. Therefore, for rental of power feed mat 10, power feed mat 10 is managed for each type.

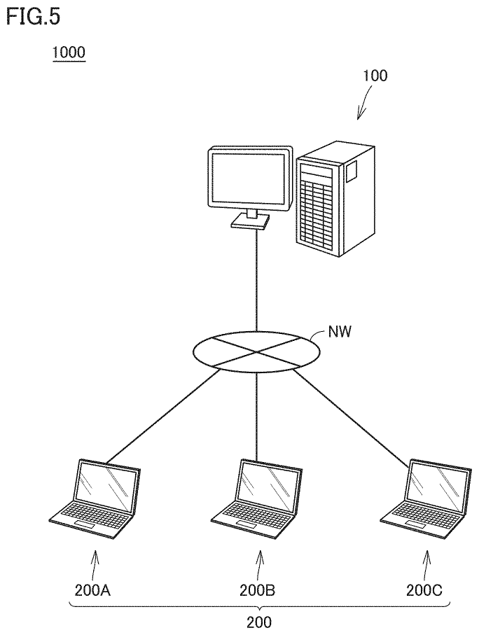

FIG. 5 is a diagram showing a schematic configuration of an information processing system according to the present embodiment. An information processing system 1000 includes a server 100 and a plurality of terminal devices 200A, 200B, and 200C. For the sake of convenience of description, any one terminal device of terminal devices 200A, 200B, and 200C is denoted as a “terminal device 200” below.

Server 100 and each terminal device 200 are configured to communicate with to each other over a network NW. Though FIG. 2 shows three terminal devices 200, the number of terminal devices 200 is not limited thereto.

Server 100 is, for example, a server of a business operator (for example, a lease business operator) that rents power feed mat 10. Server 100 may be a shared server shared by a plurality of business operators including the lease business operator. Server 100 may be a cloud server provided by a cloud server management company.

Each terminal device 200 is a device used by a user who uses a power feed mat 10 rental service provided by the lease business operator. Terminal device 200A is used in one company while terminal device 200B is used in another company. A business category of a company that uses the rental service is not particularly limited. Terminal device 200 may be a device placed at a shop or the like of the lease business operator and operated by a person in charge in the lease business operator.

<Hardware Configuration of Device>

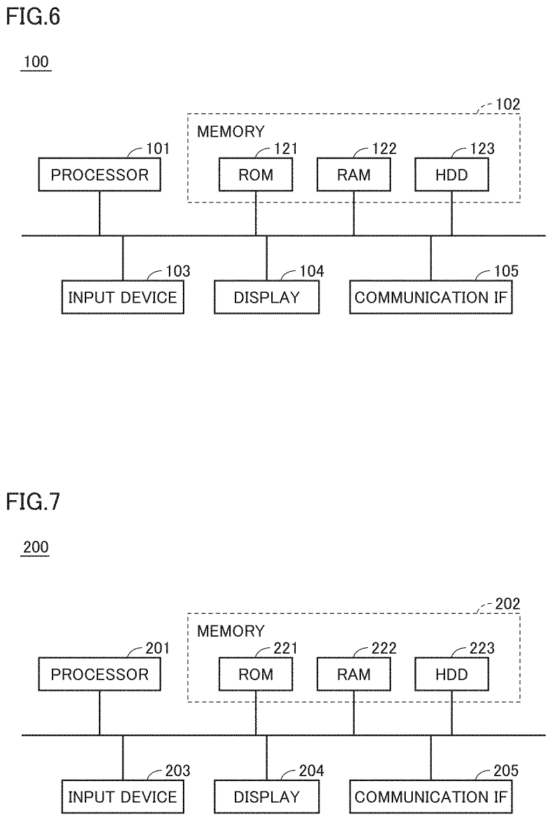

FIG. 6 is a block diagram showing a typical hardware configuration of server 100. Server 100 includes a processor 101, a memory 102, an input device 103, a display 104, and a communication interface (IF) 105. Memory 102 includes a read only memory (ROM) 121, a random access memory (RAM) 122, and a hard disk drive (HDD) 123.

Processor 101 is configured to communicate with to ROM 121, RAM 122, HDD 123, input device 103, display 104, and communication IF 105 through a bus or the like. Processor 101 controls overall operations of server 100. An operating system and an application program executed by processor 101 are stored in memory 102. Input device 103 accepts an input from a user. Input device 103 is typically implemented by a keyboard and/or a mouse. Various types of information are shown on display 104. Communication IF 105 is an interface for communication with each terminal device 200.

Memory 102 corresponds to the “storage” according to the present disclosure. At least one of display 104 and communication IF 105 corresponds to the “output device” according to the present disclosure.

FIG. 7 is a block diagram showing a typical hardware configuration of terminal device 200. Terminal device 200 includes a processor 201, a memory 202, an input device 203, a display 204, and a communication IF 205. Memory 202 includes a ROM 221, a RAM 222, and an HDD 223.

Processor 201 is configured to communicate with to ROM 221, RAM 222, HDD 223, input device 203, display 204, and communication IF 205 through a bus or the like. Processor 201 controls overall operations of terminal device 200. An operating system and an application program executed by processor 201 are stored in memory 202. Input device 203 accepts an input from a user. Input device 203 is typically implemented by a keyboard and/or a mouse. Various types of information are shown on display 204. Communication IF 205 is an interface for communication with server 100.

<Functional Configuration of System>

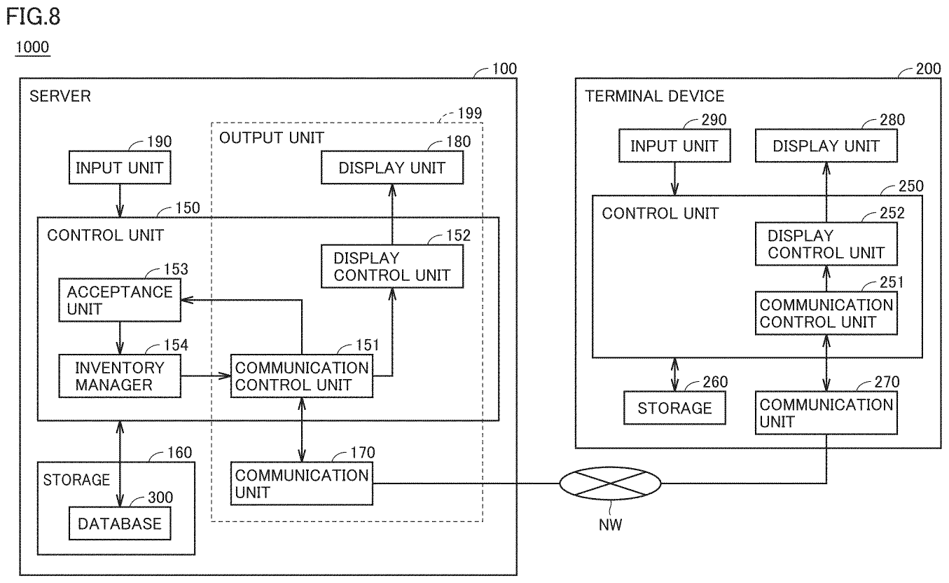

FIG. 8 is a functional block diagram for illustrating a functional configuration of server 100 and terminal device 200. Terminal device 200 includes a control unit 250, a storage 260, a communication unit 270, a display unit 280, and an input unit 290.

Control unit 250 controls overall operations of terminal device 200. Control unit 250 is a functional block implemented by execution by processor 201, of an operating system and an application program stored in memory 202. Control unit 250 includes a communication control unit 251 and a display control unit 252.

Communication control unit 251 controls communication with the outside (server 100 in this example) through communication unit 270. Display control unit 252 controls screen display on display unit 280.

An operating system and an application program are stored in storage 260. In this example, a web browser or the like is stored as the application program in storage 260. Storage 260 corresponds to memory 202 in FIG. 7.

Communication unit 270 corresponds to communication IF 205 in FIG. 7. Display unit 280 corresponds to display 204 in FIG. 7. Input unit 290 accepts an input operation from a user of terminal device 200. Input unit 290 sends a signal based on an input operation to control unit 250. Input unit 290 corresponds to input device 203 in FIG. 7.

Terminal device 200 transmits various types of data on rental of power feed mat 10 through communication unit 270 and network NW in accordance with an operation by the user onto input unit 290. More specifically, terminal device 200 transmits an ID of the user, a password of the user, inquiry data for an estimate, and data for placing a firm order (or making a reservation) to server 100.

Terminal device 200 receives data (an HTML file, image data, or the like) for showing a web page from server 100 through network NW and communication unit 270. More specifically, terminal device 200 receives data for showing a web page for logging into server 100, data for showing a data input web page for an estimate, data for showing a web page for placing a firm order, or the like from server 100. An exemplary screen shown on terminal device 200 will be described later.

Server 100 includes a control unit 150, a storage 160, a communication unit 170, a display unit 180, and an input unit 190.

Control unit 150 controls overall operations of server 100. Control unit 150 is a functional block implemented by execution by processor 101, of an operating system and an application program stored in memory 102. Control unit 150 includes a communication control unit 151, a display control unit 152, an acceptance unit 153, and an inventory manager 154. Communication control unit 151 controls communication with the outside (terminal device 200 in this example) through communication unit 170. Display control unit 152 controls screen display on display unit 180.

Acceptance unit 153 accepts an inquiry about rental of power feed mat 10 from terminal device 200 through communication unit 170 and communication control unit 151. When acceptance unit 153 accepts an inquiry about rental, acceptance unit 153 notifies inventory manager 154 of the accepted inquiry.

Inventory manager 154 manages inventory of various types of power feed mats 10 that are under its management. For example, inventory manager 154 specifies (extracts) at least one power feed mat 10 among the plurality of power feed mats 10 under the management by server 100 based on the inquiry accepted by acceptance unit 153 and database 300. Then, inventory manager 154 generates information on a procedure for inventory management in rental of at least one specified power feed mat 10 to a user. A specific method of inventory management by inventory manager 154 will be described later.

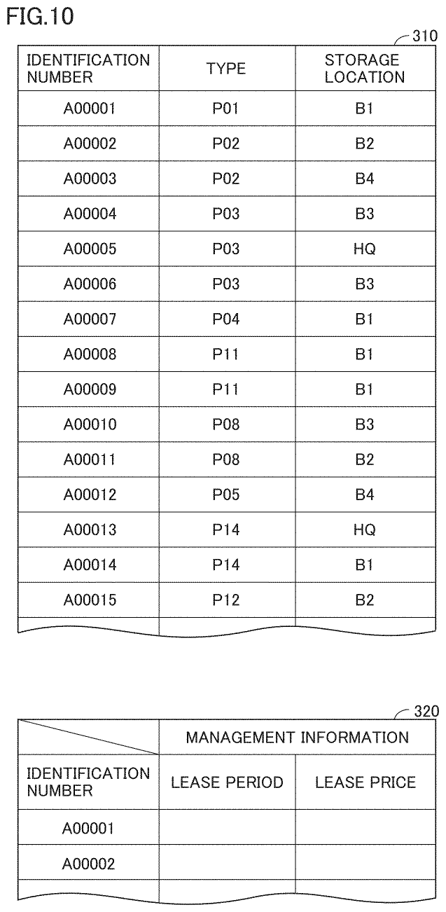

An operating system, an application program, and database 300 are stored in storage 160. Database 300 is stored in storage 160. Details of information stored in database 300 will be described in detail with reference to FIG. 10. Storage 160 corresponds to memory 102 in FIG. 6.

Communication unit 170 corresponds to communication IF 105 in FIG. 6. Display unit 180 corresponds to display 104 in FIG. 6. Input unit 190 accepts an input operation from a user of server 100. Input unit 190 sends a signal based on an input operation to control unit 150. Input unit 190 corresponds to input device 103 in FIG. 6.

An output device 199 includes communication control unit 151, communication unit 170, display control unit 152, and display unit 180. Output device 199 provides output of a result of specifying by inventory manager 154. Typically, communication control unit 151 has communication unit 170 transmit a result of specifying to terminal device 200 from which the inquiry was made. Display control unit 152 has the result of specifying shown on display unit 180.

Furthermore, acceptance unit 153 accepts an instruction to place a firm order from terminal device 200 through communication unit 170 and communication control unit 151. The firm order of power feed mat 10 is thus placed. When the firm order is placed, control unit 150 transmits data indicating placement of the firm order (data for showing a web page) to terminal device 200 that placed the order.

<Inventory Management>

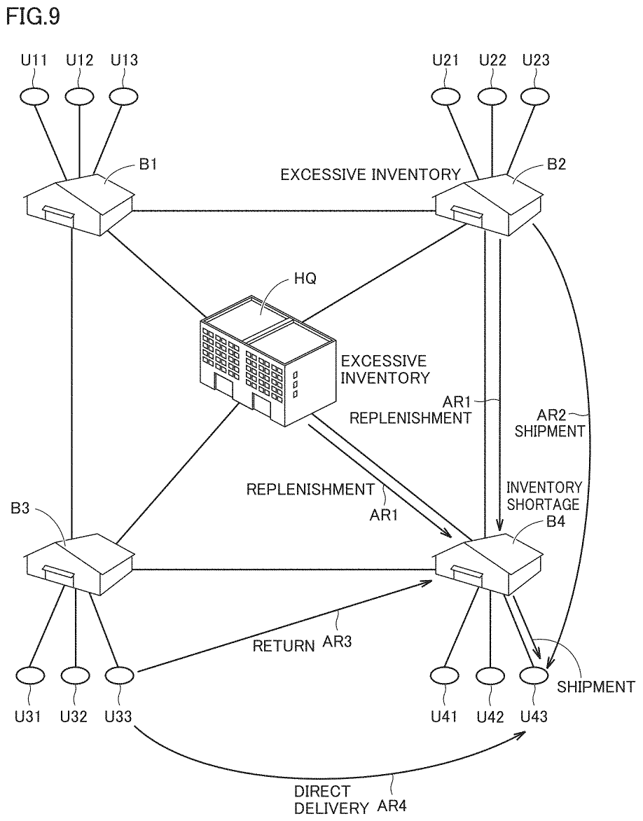

FIG. 9 is a diagram for illustrating overview of management of inventory of power feed mat 10 carried out in the present embodiment. A plurality of power feed mats 10 are stored as being distributed at a plurality of storage locations. In an example shown in FIG. 9, the plurality of power feed mats 10 are stored at at least one of a headquarter HQ and four branches B1 to B4. Users (U11 to U13 and the like) are present in an area around each storage location.

Storage as being distributed at a plurality of storage locations allows shipment of power feed mat 10 from a storage location closer to an address of a user (which may be a location of placement of power feed mat 10 designated by the user). For example, when orders are received from users U31 to U33 in an area around branch B3, efficient flow of goods can be achieved by shipping power feed mat 10 of the ordered type from branch B3. On the other hand, in distributed storage, inventory of various types of power feed mats 10 should appropriately be managed. When inventory of at least one type of power feed mat 10 is insufficient at a certain storage location, power feed mat 10 of the type that fulfills the order may not be shipped from that storage location.

Then, in the present embodiment, a configuration in which necessary inventory of power feed mat 10 is interchanged among a plurality of storage locations (headquarter HQ and four branches B1 to B4 in this example) or a source of rental and/or a return destination of power feed mat 10 is/are adjusted is adopted. For facilitating understanding, description will be given with reference to specific examples. A situation that inventory of a specific type of power feed mat (for example, power feed mat 10A shown in FIG. 2) is insufficient at branch B4, whereas inventory of power feed mat 10A is excessive at headquarter HQ and branch B2 is assumed.

In this case, server 100 can instruct headquarter HQ and branch B2 to replenish branch B4 with power feed mat 10A (see an arrow AR1). Power feed mat 10A can thus be shipped to a user U43 from branch B4 that has received replenishment. For example, when an order for power feed mat 10A is received from user U43 before the replenishment, server 100 may instruct branch B2 in place of branch B4 to ship power feed mat 10A to user U43 (see an arrow AR2).

Furthermore, when already placed power feed mat 10A is returned from user U33 in the area around branch B3, server 100 may request user U33 to return power feed mat 10A to branch B4 where inventory is insufficient, instead of branch B3 (see an arrow AR3). Alternatively, server 100 may request user U33 to directly deliver power feed mat 10A to next user U43, without branch B4 being interposed (see an arrow AR4).

When user U33 is requested to return power feed mat 10A to a destination other than B3 or user U33 is requested to deliver power feed mat 10A to next user U43, user U33 is desirably granted an incentive. For example, user U33 can be given a discount in next rental of power feed mat 10.

By thus replenishing power feed mat 10 between a plurality of storage locations, adjusting a source of rental of new power feed mat 10, or adjusting a return destination of already placed power feed mat 10, an appropriate amount of inventory can be ensured at a storage location where a specific type of power feed mat 10 is insufficient. Consequently, delivery time for power feed mat 10 can be shortened and an order from a user can promptly be fulfilled.

<Database>

Database 300 shown in FIG. 8 includes a data table 310, a data table 320, and a data table 330.

FIG. 10 is a conceptual diagram for illustrating a schematic configuration of data tables 310 and 320. In data table 310, an identification number of power feed mat 10, a type of power feed mat 10, and a current storage location of power feed mat 10 are associated with one another. For example, a type “P01” and a storage location “branch B1” are associated with an identification number “A00001” of the power feed mat.

In data table 320, management information is associated with an identification number of each of the plurality of power feed mats 10. The management information includes, for example, a lease period and a lease price.

The lease period may include information on the lease period of power feed mat 10 that has already been rented and information on the lease period of power feed mat 10 which will be rented. More specifically, flag information (not shown) indicating whether or not the power feed mat has already been rented is associated with the identification number of power feed mat 10. When the power feed mat has already be rented, information on the day of rental and information on a scheduled day of return are further associated. Furthermore, flag information indicating whether or not rental of the power feed mat is scheduled is associated with the identification number of power feed mat 10. When rental of the power feed mat is scheduled (reserved), information on a scheduled day of start of rental and information on a scheduled day of return are further associated.

The lease price may include information on the lease price of power feed mat 10 which has already been rented or will be rented and information on the lease price of power feed mat 10 available for rental. Such information is also associated with the identification number of power feed mat 10.

FIG. 11 is a conceptual diagram for illustrating a schematic configuration of data table 330. In data table 330, basic function information and additional function information are associated with each of a plurality of types (P01, P02, . . . ). The basic function information includes, for example, a size of power feed mat 10, a power transmission coil specification, and information on power feed capability.

More specifically, with the “size” of power feed mat 10, for each type of power feed mat 10, a length in a longitudinal direction (unit: centimeter) and a length in a lateral direction of that type are associated. Each power feed mat 10 may be identical in size in the longitudinal direction and the lateral direction.

With the “power transmission coil specification” of power feed mat 10, for each type of power feed mat 10, a shape (a quadrangular shape, a hexagonal shape, or a shape of a solenoid) of the power transmission coil included in that type and the number of power transmission coils are associated.

With “power feed capability” of power feed mat 10, for each type of power feed mat 10, power feed capability of that type is associated. A current value of power feed capability is expressed by a maximum amount of electric power (unit: kWh) that can be fed at the current time point by power feed mat 10.

The additional function information includes information on the plurality of functional layers described with reference to FIGS. 2 to 4. The conceptual diagram in FIG. 11 shows a functional layer included in power feed mat 10 of each type with a circle. For example, the power feed mat of the type “P01” includes the load-carrying and waterproof functional layer (first protective layer 411), the snow melting layer (second protective layer 412), heat radiation layer 42, representation layer 43, shield layer 44, foreign matter sensing layer 45, and living body sensing layer 46 similarly to power feed mat 10A (see FIG. 2). The power feed mat of a type “P02” includes the load-carrying and waterproof functional layer, the snow melting layer, heat radiation layer 42, representation layer 43, and shield layer 44 similarly to power feed mat 10B (see FIG. 3). The power feed mat of a type “P03” includes the load-carrying and waterproof functional layer and shield layer 44 similarly to power feed mat 10C (see FIG. 4).

Thus, in database 300, data table 310 and data table 330 include as an item, the type (P01, P02, . . . ) of the power feed mat in common. Thus, between data table 310 and data table 330, the information on the basic function and the additional function is associated with the identification number of each of the plurality of power feed mats 10.

Data tables 310 and 320 are updated automatically or manually. In data table 310, the item “storage location” is updated to agree with the actual storage location of power feed mat 10. Information on new power feed mat 10 may be added to data table 310 or information on decommissioned power feed mat 10 may be deleted from data table 310. The management information in data table 320 is also similarly updated.

<User Interface of Terminal Device>

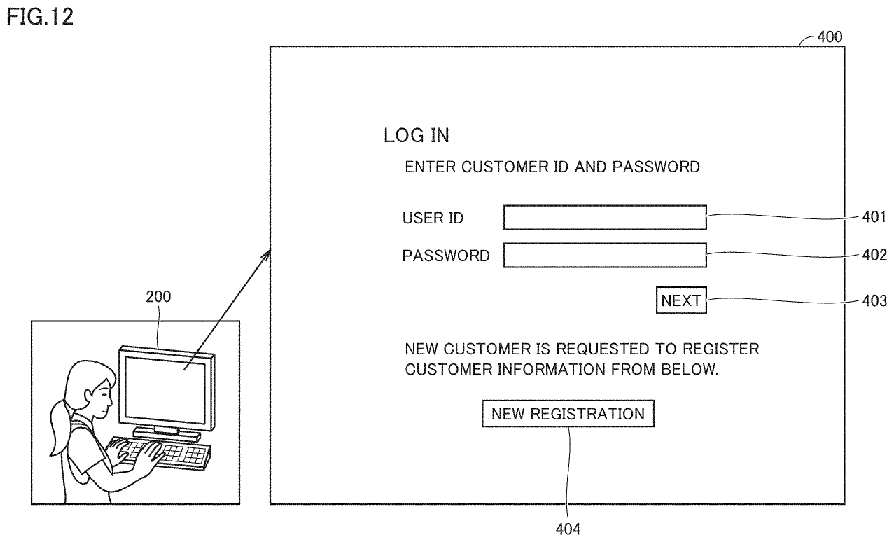

FIG. 12 is a diagram showing a log-in screen of terminal device 200. A log-in screen 400 includes a field 401 of input of a user ID, a field 402 of input of a password, a button 403 for transition to a next screen, and a button 404 for transition to a screen for new registration. Buttons 403 and 404 are graphical user interface (GUI) buttons.

When a user uses a power feed mat 10 rental service for the first time, the user makes user registration by selecting button 404. At the time of new registration of the user, information processing system 1000 accepts input of a name of the user (for example, an individual name or a corporate name), a contact of the user, an address of the user, an industry of the user, the password, and the like.

When the user has already made user registration, the user enters the user ID into field 401 of input and enters the password in field 402 of input. Thereafter, the user selects button 403. The user ID and the password are thus transmitted to server 100 and server 100 authenticates the user. When user authentication is successful, server 100 uniquely specifies the user.

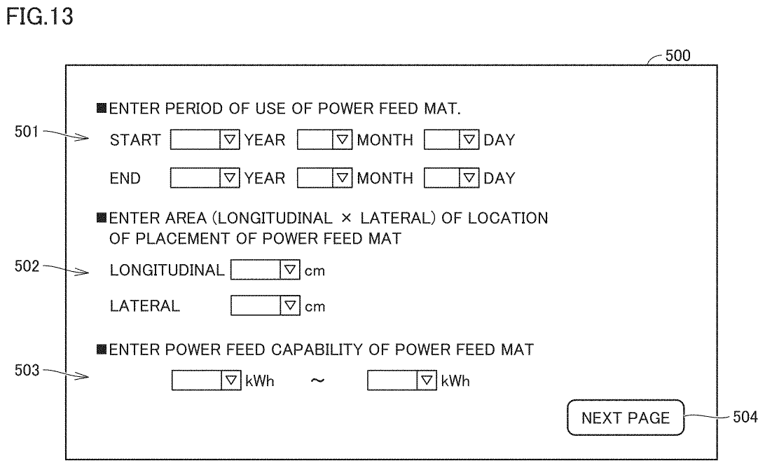

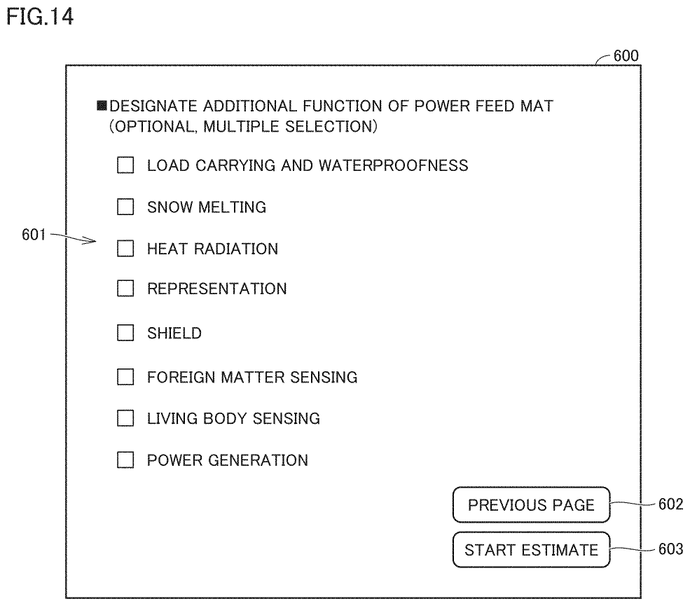

FIG. 13 is a first diagram showing an input screen for making an inquiry about rental of power feed mat 10. FIG. 14 is a second diagram showing an input screen for making an inquiry about rental of power feed mat 10.

Referring to FIG. 13, an input screen 500 includes a field 501 of input of the lease period of power feed mat 10, a field 502 of input of an area of a point of placement of power feed mat 10, a field 503 of input of power feed capability of power feed mat 10, and a GUI button 504 for moving to a next input screen.

In this example, in data table 310, size information of power feed mat 10 is associated with the identification number of power feed mat 10 (see FIG. 11).

Therefore, server 100 can calculate the type and the number of necessary power feed mats 10 based on the area of the point of placement of power feed mat 10. Input screen 500 may accept an input designating the size and an input designating the number.

The user of terminal device 200 enters each item in input screen 500 and thereafter selects button 504. A next input screen 600 shown in FIG. 14 is thus shown. Input screen 600 includes a field 601 of input for designating the additional function of power feed mat 10. The user enters the functional layer to additionally be provided in power feed mat 10 among the plurality of functional layers described previously.

The user of terminal device 200 can return to a previous page (input screen 500) as necessary by operating a button 602. The user designates the additional function in input screen 600 and thereafter selects button 603. Information on each item inputted in input screens 500 and 600 is thus transmitted to server 100.

An entity that performs an input operation onto input screens 500 and 600 is not limited to the user of power feed mat 10, and may be a person in charge (an engineer, a salesperson, or a manager) belonging to a business operator (for example, a lease company) of power feed mat 10. The person in charge can input each piece of information above based on a result of hearing from a user about specifications requested to power feed mat 10.

Server 100 specifies the type of power feed mat 10 to be rented to the user based on information inputted in input screens 500 and 600. Furthermore, server 100 specifies the identification number of the power feed mat to be rented to the user based on a status of inventory of power feed mat 10 of the type and the address of the user (for example, information on the point of placement of power feed mat 10). When inventory of power feed mat 10 of the type is available at the storage location (branches B1 to B4) around the user, server 100 indicates shipment from that storage location. When inventory of power feed mat 10 of the type is not available at the storage location around the user, server 100 may indicate delivery of power feed mat 10 from another storage location (see arrow AR2 in FIG. 9) or may request delivery of power feed mat 10 which will be returned from another user (see arrow AR4 in FIG. 9).

Server 100 transmits information on power feed mat 10 specified above to terminal device 200. For example, server 100 makes an estimate of power feed mat 10 and transmits a result of the estimate to terminal device 200.

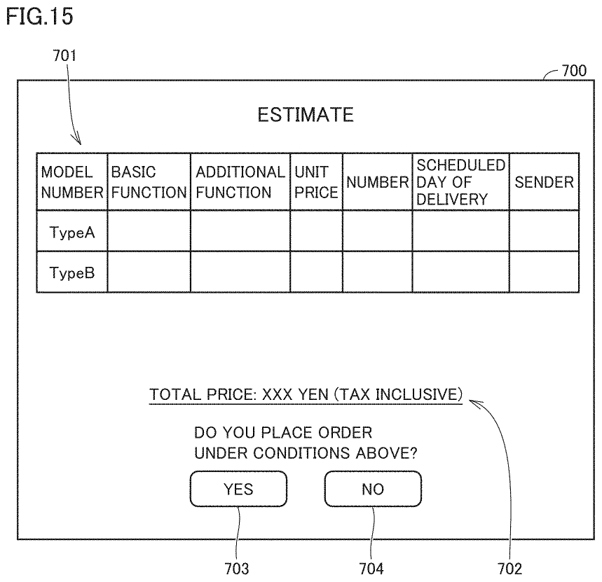

FIG. 15 is a diagram showing a screen of a result of the estimate of power feed mat 10. A screen 700 showing a result of the estimate includes information 701 on power feed mat 10 to be rented, information 702 on a total amount, a button 703 for placing an order, and a button 704 for not placing the order. Information 701 includes information on the basic function (the size, the power transmission coil specification, power feed capability, and the like) of power feed mat 10, the additional function (the load-carrying and waterproof function, the snow melting function, and the like), the unit price, and the number. Additionally, information 701 may include information on a scheduled day of delivery when power feed mat 10 arrives at the user and information on a sender of power feed mat 10. Information 701 may include information other than that (information on the lease period). When the user selects button 703, the order for power feed mat 10 is fixed in server 100.

<Processing Sequence>

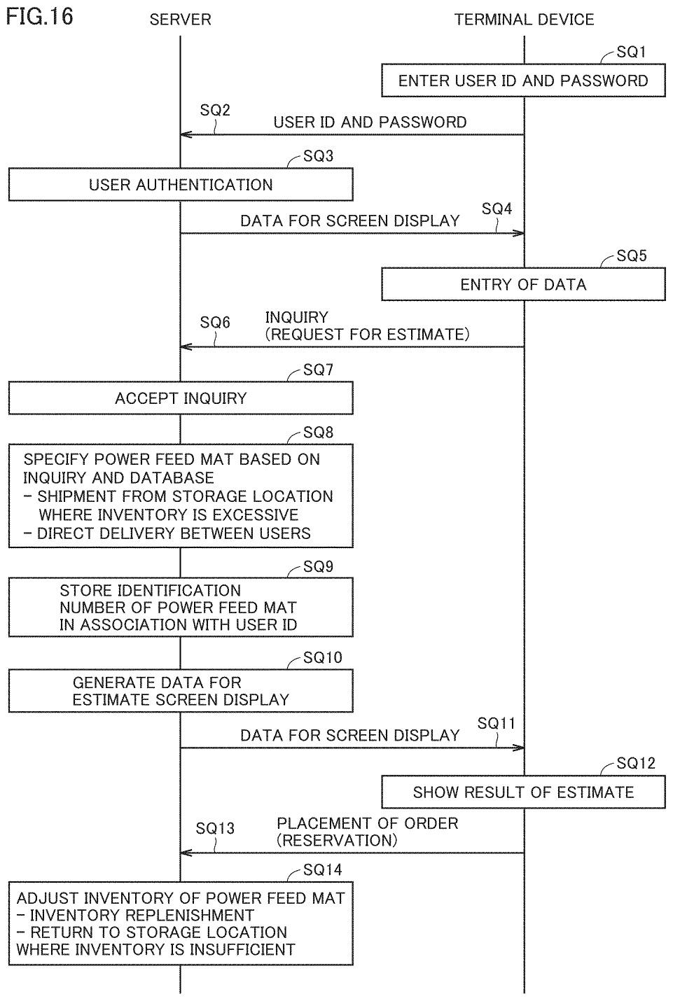

FIG. 16 is a sequence diagram for illustrating a flow of processing performed in information processing system 1000. For the sake of convenience of description, processing after log-in screen 400 shown in FIG. 12 is shown on terminal device 200 will be described below. A sequence is denoted as “SQ” below.

In SQ1, terminal device 200 accepts entry of a user ID and a password. In SQ2, terminal device 200 transmits the user ID and the password to server 100. In SQ3, server 100 authenticates the user of terminal device 200 based on the received user ID and password.

In SQ4, server 100 transmits data for showing inquiry input screens 500 and 600 (see FIGS. 11 and 12) to terminal device 200. Specifically, server 100 transmits data for showing a web page to terminal device 200. In SQ5, terminal device 200 shows input screens 500 and 600 and accepts inquiry data input into input screens 500 and 600.

In SQ6, terminal device 200 transmits inquiry information to server 100. Specifically, being triggered by selection of estimate start button 603 (see FIG. 14), terminal device 200 transmits inquiry information to server 100.

In SQ7, server 100 accepts the inquiry about rental of power feed mat 10. In SQ8, server 100 specifies at least one power feed mat 10 among the plurality of power feed mats 10 based on the inquiry and data tables 310, 320, and 330 (see FIGS. 10 and 11) stored in database 300. At this time, server 100 may prepare a plan for shipment of power feed mat 10 from a storage location where inventory is sufficient (see arrow AR2 in FIG. 9). Server 100 may set the return destination of power feed mat 10 such that power feed mat 10 to be returned is delivered from another user to a new user (see arrow AR4 in FIG. 9).

In SQ9, server 100 has the user ID stored in association with identification information of power feed mat 10.

In SQ10, server 100 generates data for showing an estimate on terminal device 200 (data for screen display). In SQ11, server 100 transmits the generated data for screen display to terminal device 200.

In SQ12, terminal device 200 shows screen 700 showing a result of the estimate (see FIG. 15). In SQ13, being triggered by selection of button 703 for placing an order, terminal device 200 issues an order to server 100.

In SQ14, server 100 performs processing for adjusting inventory of power feed mat 10. More specifically, in shipment of power feed mat 10 of the ordered type to the user, when inventory of the type is insufficient at the storage location which is the source of shipment, server 100 generates an instruction for replenishment of the type from the storage location where inventory is excessive to the storage location where inventory is insufficient (see arrow AR1 in FIG. 9). Server 100 may generate a request for return of power feed mat 10 to the storage location where inventory of the type is insufficient, to a user whose lease period has expired (or is about to expire) (see arrow AR3 in FIG. 9).

Thereafter, the manager of power feed mat 10 performs processing for shipping power feed mat 10 ordered by the user from the storage location of power feed mat 10 to the user at prescribed timing. Through such a series of processing, power feed mat 10 is rented to the user.

As set forth above, in the present embodiment, the storage location which is the source of rental and/or the storage location which is the return destination are/is determined to ensure inventory of a plurality of types of power feed mats 10 at each of the plurality of storage locations such as headquarter HQ and branches B1 to B4. Thus, such a situation that inventory of power feed mat 10 is insufficient at any storage location and response to an inquiry about rental from a user cannot quickly be made (delivery cannot immediately be made) is suppressed. Therefore, according to the present embodiment, inventory of power feed mat 10 can appropriately be managed.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A server that manages a plurality of power feed mats stored as being distributed at a plurality of storage locations, each of the power feed mats being configured to supply electric power to a movable body, the server comprising:
a storage that stores data in which an identification number, a type, and a storage location of each of the plurality of power feed mats are associated with one another;
a processor that determines a type of a power feed mat to be rented among the plurality of power feed mats based on the data, in response to an inquiry from a user; and
an output device that outputs determination by the processor, wherein
the processor determines a storage location to be a source of rental or a storage location to be a return destination among the plurality of storage locations such that inventory of a plurality of types of power feed mats is ensured at each of the plurality of storage locations.

2. The server according to claim 1, wherein
the processor determines a storage location where the inventory of at least one type of the plurality of types of power feed mats is excessive, as the storage location to be the source of rental.

3. The server according to claim 1, wherein
the processor determines a storage location where the inventory of at least one type of the plurality of types of power feed mats is insufficient, as the storage location to be the return destination.

4. The server according to claim 1, wherein
the processor determines to replenish the inventory from a storage location where the inventory is excessive to a storage location where the inventory is insufficient, for at least one type of the plurality of types of power feed mats.

5. The server according to claim 1, wherein
each of the plurality of power feed mats includes
a substrate including a power transmission coil, and
a functional body that performs at least one function of a plurality of functions different from a power feed function, and
the inquiry includes an instruction that designates the at least one function.

6. The server according to claim 5, wherein
the plurality of functions include at least one of a function to reduce stress concentration, a waterproof function, a snow melting function, a heat radiation function, a representation function, an electromagnetic wave shielding function, a foreign matter sensing function, and a living body sensing function.

7. The server according to claim 1, wherein
the output device outputs determination by the processor to a terminal device configured to communicate with the server.

8. An information processing system comprising:
the server according to claim 7; and
the terminal device.

9. An information processing method for managing a plurality of power feed mats stored as being distributed at a plurality of storage locations, each of the plurality of power feed mats being configured to supply electric power to a movable body, the information processing method comprising:
accepting, by an information processing apparatus, an inquiry from a user; and
determining, by the information processing apparatus, a type of a power feed mat to be rented among the plurality of power feed mats in response to the inquiry, based on data in which an identification number, a type, and a storage location of each of the plurality of power feed mats are associated with one another, wherein
the determining includes determining a storage location to be a source of rental or a storage location to be a return destination among the plurality of storage locations such that inventory of a plurality of types of power feed mats is ensured at each of the plurality of storage locations.
